(19) United States
(12) Patent Application Publication
(10) Pub. No.: US 2021/0294482 A1
(43) Pub. Date: Sep. 23, 2021

(54) INFORMATION PROCESSING DEVICE, INFORMATION PROCESSING METHOD, AND PROGRAM

(71) Applicant: SONY CORPORATION, TOKYO (JP)

(72) Inventors: TAKUYA IKEDA, TOKYO (JP); KENTARO IDA, TOKYO (JP); YOUSUKE KAWANA, TOKYO (JP); MAKI IMOTO, TOKYO (JP); RYUICHI SUZUKI, TOKYO (JP)

(21) Appl. No.: 16/336,615

(22) PCT Filed: Aug. 23, 2017
(86) PCT No.: PCT/JP2017/030147

§ 371 Date: Mar. 26, 2019

(30) Foreign Application Priority Data
Oct. 19, 2016 (JP) 2016-204952

(51) Int. Cl. G06F 3/0484; G06F 3/01

(52) U.S. Cl. CPC G06F 3/04842; G06F 3/017

(57) ABSTRACT

[Object] To make it possible to select an operation target more easily. [Solution] An information processing device according to the present technology includes: a first selecting unit configured to control selection of a selection target including an operation target on the basis of information related to a first operation on the selection target by an operating entity; a setting unit configured to set an operation region corresponding to the selected selection target in a first object; and a second selecting unit configured to control selection of the operation target on the basis of information related to a second operation on the first object in which the operation region is set by the operating entity.

### TECHNICAL FIELD

The present disclosure relates to an information processing device, an information processing method, and a program.

### BACKGROUND ART

Techniques for remotely controlling devices such as home electric appliances or information devices have been proposed. For example, techniques for a user to remotely control such devices using a gesture of a hand, body, or the like have been developed.

A technique of identifying a finger of a user located in a certain environment, recognizing a direction in which the finger is directed, and pointing to a device on the basis of a recognition result is disclosed in Patent Literature 1.

### CITATION LIST

### Patent Literature

Patent Literature 1: JP 2013-205983A

### DISCLOSURE OF INVENTION

### Technical Problem

However, in the technique disclosed in Patent Literature 1, it is necessary to move the finger in the air and direct a fingertip toward a device of an operation target. In this case, since the direction in which the finger is directed is unstable, and a pointing recognition error is large, it is difficult for the user to select an operation target.

In this regard, the present disclosure proposes an information processing device, an information processing method, and a program which are novel and improved and capable of selecting an operation target more easily.

### Solution to Problem

According to the present disclosure, there is provided an information processing device, including: a first selecting unit configured to control selection of a selection target including an operation target on the basis of information related to a first operation on the selection target by an operating entity; a setting unit configured to set an operation region corresponding to the selected selection target in a first object; and a second selecting unit configured to control selection of the operation target on the basis of information related to a second operation on the first object in which the operation region is set by the operating entity.

In addition, according to the present disclosure, there is provided an information processing method, including: controlling, by a processor, selection of a selection target including an operation target on the basis of information related to a first operation on the selection target by an operating entity; setting, by the processor, an operation region corresponding to the selected selection target in a first object; and controlling, by the processor, selection of the operation target on the basis of information related to a second operation on the operation region set in the first object by the operating entity.

In addition, according to the present disclosure, there is provided a program causing a computer to function as: a first selecting unit configured to control selection of a selection target including an operation target on the basis of information related to a first operation on the selection target by an operating entity; a setting unit configured to set an operation region corresponding to the selected selection target in a first object; and a second selecting unit configured to control selection of the operation target on the basis of information related to a second operation on the first object in which the operation region is set by the operating entity.

### Advantageous Effects of Invention

As described above, according to the present disclosure, it is possible to select an operation target more easily.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an overview of an information processing system 1A according to a first embodiment of the present disclosure.

FIG. 2 is a diagram illustrating a configuration example of an information processing system 1A according to the embodiment.

FIG. 3 is a block diagram illustrating a functional configuration example of a control unit 100 according to the embodiment.

FIG. 4 is a flowchart illustrating an example of a flow of a process of a first stage by an information processing system 1A according to the embodiment.

FIG. 5 is a diagram for describing a first example of display control by a display control unit 106 according to the embodiment.

FIG. 6 is a diagram for describing a second example of display control by a display control unit 106 according to the embodiment.

FIG. 7 is a diagram for describing a third example of display control by a display control unit 106 according to the embodiment.

FIG. 8 is a diagram for describing a fourth example of display control by a display control unit 106 according to the embodiment.

FIG. 9 is a flowchart illustrating an example of a flow of a process of a second stage by an information processing system 1A according to the embodiment.

FIG. 10 is a diagram illustrating an example of setting an operation region by a setting unit 104 according to the embodiment.

FIG. 11 is a diagram illustrating another example of setting an operation region.

FIG. 12 is a diagram for describing an example of display control by a display control unit 106 according to the embodiment.

FIG. 13 is a flowchart illustrating a flow of a process of a first stage according to a first modified example of the information processing system 1A according to the embodiment.

FIG. 14 is a diagram illustrating a control example according to a second modified example of the information processing system 1A according to the embodiment.

FIG. 15 is a diagram illustrating a control example according to a second modified example of the information processing system 1A according to the embodiment.

FIG. 16 is a diagram illustrating a control example according to a third modified example of the information processing system 1A according to the embodiment.

FIG. 17 is a diagram illustrating a control example according to a third modified example of the information processing system 1A according to the embodiment.

FIG. 18 is a flowchart illustrating a flow of a process of a second stage according to a fourth modified example of the information processing system 1A according to the embodiment.

FIG. 19 is a diagram illustrating a control example according to a fourth modified example of the information processing system 1A according to the embodiment.

FIG. 20 is a diagram illustrating an overview of an information processing system 1B according to a second embodiment of the present disclosure.

FIG. 21 is a diagram illustrating a configuration example of an information processing system 1B according to the embodiment.

FIG. 22 is a diagram illustrating an overview of an information processing system 1C according to a third embodiment of the present disclosure.

FIG. 23 is a diagram illustrating a configuration example of an information processing system 1C according to the embodiment.

FIG. 24 is a block diagram illustrating a functional configuration example of a control unit 100C according to the embodiment.

FIG. 25 is a block diagram illustrating a hardware configuration example of an information processing apparatus 900 according to an embodiment of the present disclosure.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, the description will proceed in the following order.
1. First embodiment
1.1. Overview of information processing system
1.2. Configuration example of control unit
1.3. Process example
1.4. Modified example
2. Second embodiment
3. Third embodiment
3.1. Overview of information processing system
3.2. Configuration example of control unit
4. Hardware configuration example
5. Conclusion

### 1. First Embodiment

### <1.1. Overview of Information Processing System>

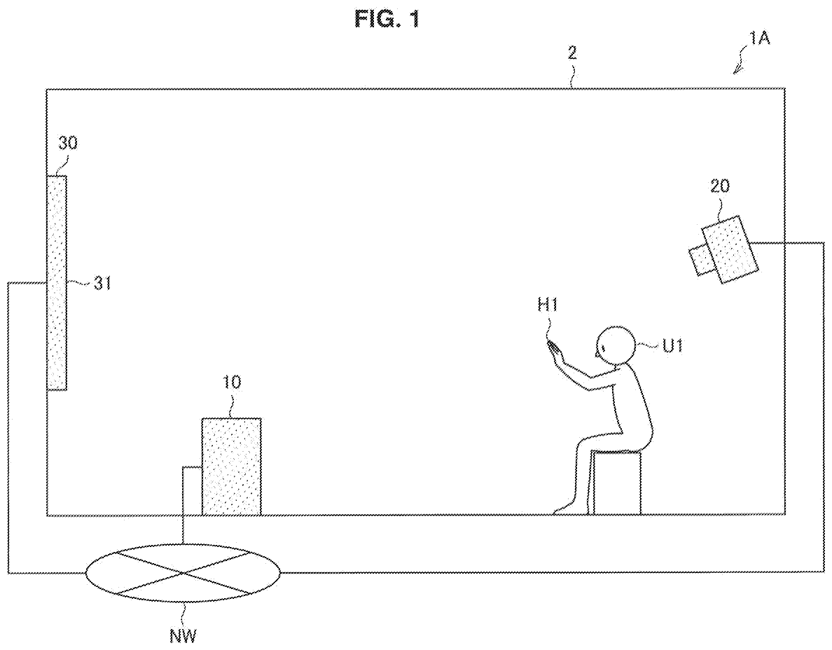

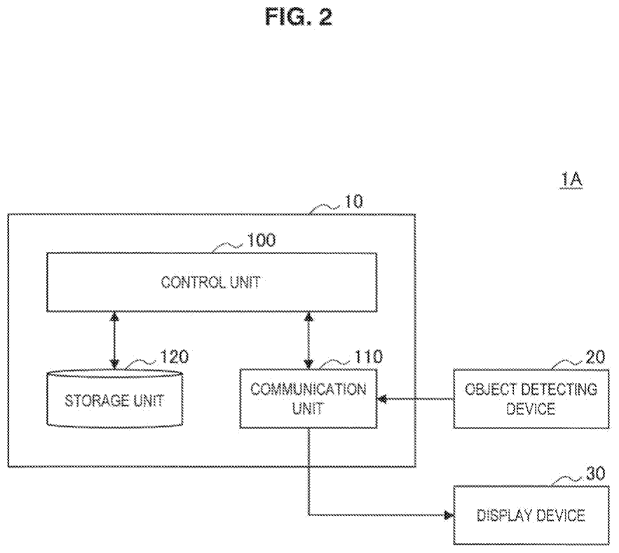

FIGS. 1 and 2 are diagrams illustrating an overview and a configuration example of an information processing system 1A in accordance with the first embodiment of the present disclosure. As illustrated in FIG. 1, the information processing system 1A according to the present embodiment includes the information processing device 10, the object detecting device 20, and the display device 30.

The information processing system 1A according to the present embodiment is applied to an arbitrary space (a space 2 in FIG. 1) in which an operation target is installed, acquires information related to an operation on an operation target by a user U1 located in the space 2 by the object detecting device 20, and selects an operation target on the basis of such detection information. A virtual object displayed in a display region or the like of the display device 30 to be described later is an example of an operation target according to the present embodiment.

Further, such an operation target may be a physical object such as a button, a switch, a lever, a knob, or the like installed on a wall surface or the like of the space 2 or may be the wall surface of the space 2 itself. Further, in a case in which the operation target is a virtual object, a shape, a size, a position, a type, and the like of the operation target are not particularly limited as long as it is a display form of accepting an input on the basis of an operation of the user. The respective devices will be described below.

### (Information Processing Device)

The information processing device 10 is a device having an information processing function for acquiring detection information obtained from the object detecting device 20 and performing a predetermined control process based on the detection information. The information processing device 10 may include a processing circuit, a storage device, a communication device, and the like. The information processing device 10 can be realized by any device such as a personal computer (PC), a tablet, or a smartphone. Further, as illustrated in FIG. 1, the information processing device 10 may be realized by an information processing device arranged in the space 2 or may be realized by one or more information processing devices on a network as in cloud computing.

As illustrated in FIG. 2, the information processing device 10 includes a control unit 100, a communication unit 110, and a storage unit 120.

### (Control Unit)

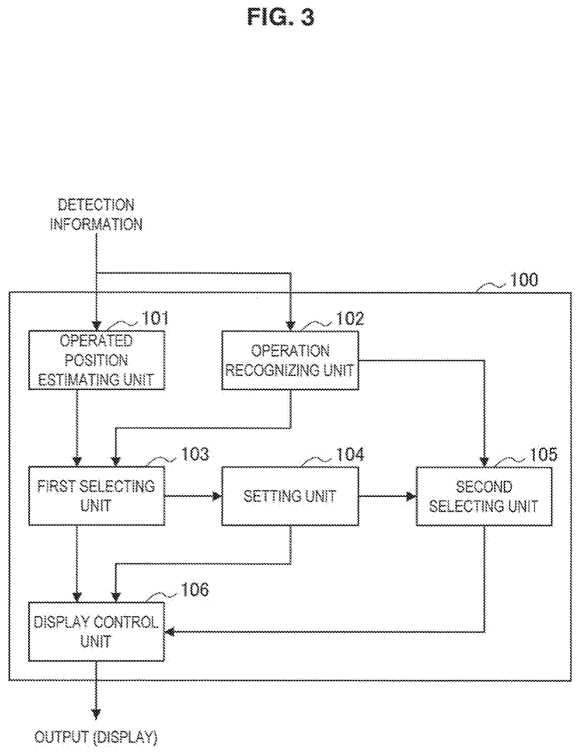

The control unit 100 controls overall operation of the information processing device 10 according to the present embodiment. The function of the control unit 100 is realized by a processing circuit such as a central processing unit (CPU) included in the information processing device 10. Further, the control unit 100 has functions realized by respective functional units illustrated in FIG. 3 to be described later and plays a leading role in performing an operation of the information processing device 10 according to the present embodiment. The functions of the respective functional units included in the control unit 100 will be described later.

### (Communication Unit)

The communication unit 110 is a communication device included in the information processing device 10, and carries out various types of communications with an external device via a network (or directly) in a wireless or wired manner. The function of the communication unit 110 is realized by a communication device included in the information processing device 10. Specifically, the communication unit 110 is realized by a communication device such as a communication antenna and a radio frequency (RF) circuit (wireless communication), an IEEE 802.15.1 port and a transmission/reception circuit (wireless communication), an IEEE 802.11b port and a transmission/reception circuit (wireless communication), or a local area network (LAN) terminal and a transmission/reception circuit (wired communication). For example, as illustrated in FIG. 1, the communication unit 110 performs communication with the object detecting device 20 and the display device 30 via a network NW. Specifically, the communication unit 110 acquires detection information from the object detecting device 20, and outputs information related to control of display generated by the control unit 100 to the display device 30. Further, the communication unit 110 may perform communication with other devices not illustrated in FIGS. 1 and 2.

### (Storage Unit)

The storage unit 120 is a storage device included in the information processing device 10, and stores information acquired by the communication unit 110, information obtained by processes of the respective functional units of the control unit 100, and the like. The storage unit 120 is realized by, for example, a magnetic recording medium such as a hard disk, a non-volatile memory such as a flash memory, or the like. Further, the storage unit 120 appropriately outputs stored information in response to a request from each functional unit included in the control unit 100 or from the communication unit 110. For example, the storage unit 120 may store a pattern such as a form or the like of a hand related to a gesture by the user in advance and may output the pattern such as the form or the like of the hand to the control unit 100 when the control unit 100 recognizes the detected gesture.

### (Object Detecting Device)

The object detecting device 20 is an example of a detecting device that detects a form of the body of the user. The object detecting device 20 according to the present embodiment detects an object (detected body) such as the body of the user and generates three-dimensional position information of the detected body as detection information. The generated three-dimensional position information is output to the information processing device 10 via the network NW (or directly). Further, as illustrated in FIG. 1, for example, the object detecting device 20 according to the present embodiment is installed at a position (a ceiling or a wall) at which the user U1 can be detected in the space 2 in which the information processing system 1A is used.

The object detecting device 20 according to the present embodiment can be realized by a depth sensor. Further, the object detecting device 20 may be realized by, for example, a stereo camera or the like. Further, the object detecting device 20 may be realized by a sensor capable of performing distance measurement using an infrared sensor, a time of flight (TOF) type sensor, an ultrasonic sensor, or the like or may be realized by a device which projects an IR laser pattern. In other words, the object detecting device 20 is not particularly limited as long as it can detect the position of the body of the user U1 in the space 2.

Further, in another embodiment, the information processing system 1A may be equipped with a device capable of detecting a line of sight or the like of the user instead of the object detecting device 20. Such a device may be realized, for example, by an image recognition sensor or the like capable of identifying the line of sight or the like of the user by image recognition for an image obtained by imaging a face of the user.

Further, in the example illustrated in FIG. 1, the object detecting device 20 is described as being arranged on the ceiling or the wall of the space 2, but the present technology is not limited to this example. For example, in another embodiment, the object detecting device 20 may be a device held in the hand of the user. Such a device may be a pointing device using a gyro mouse, an infrared sensor, or the like.

Further, in another embodiment, the object detecting device 20 may be a wearable device worn on the head, the arm, or the like of the user. Various types of inertial sensors or mechanical sensors such as a gyro sensor, a potentiometer, and an encoder are installed in such wearable devices, and the form or the like of the body of the user may be detected by each sensor. Further, in another embodiment, a marker may be installed on the head or the upper limb of the user, and the object detecting device 20 may detect the form or the like of the body of the user by recognizing such a marker.

### (Display Device)

The display device 30 is a device which is arranged in the space 2 to which the information processing system 1A is applied, and displays a predetermined screen and information output from the information processing device 10 via the network NW (or directly) in a display region 31. Although the details will be described later, the display in the display region of the display device 30 according to the present embodiment is controlled, for example, by the information processing device 10.

For example, as illustrated in FIG. 1, the display device 30 according to the present embodiment can be realized by a display device such as a liquid crystal display or an organic electro luminescence (EL) display which is arranged on the wall of the space 2 to which the information processing system 1A is applied, but the present technology is not limited to such an example. For example, the display device 30 may be a fixed display device which is fixedly installed at an arbitrary position of the space 2. Further, the display device 30 may also be a portable display device having a display region such as a tablet, a smartphone, or a laptop PC. In a case in which the portable display device is used without being fixed, it is desirable if position information of such a display device 30 can be acquired. Further, the display device 30 may be a projection type display device which sets a display region in an arbitrary wall body and projects a display onto the display region such as a projector. Further, a shape of such a display region is not particularly limited. Further, such a display region may be a flat surface or a curved surface.

In the information processing system 1A, a virtual object which is an operation target displayed in the display region 31 of the display device 30 is specified by a gesture, a pointing operation, or the like using the hand of the user U1. Accordingly, the operation target is selected by the user U1.

However, in a case in which it is desired to select an operation target which is located remotely by a form or a motion of the hand or the like such as a gesture or a pointing operation, it may be difficult to select the operation target accurately. For example, it is difficult to accurately select the operation target due to an error caused by recognition accuracy of a sensor that detects the form or the motion of the hand, a drift phenomenon in a case in which a gyro sensor or the like is used, or the like. In other words, in order to select the operation target accurately, a strict operation of the form or the motion of the hand by the user is required. However, in this case, since the user performs an operation in a state in which the hand floats in the air, a physical burden on the user increases.

In this regard, the present disclosure proposes technology that enables the user to more easily select the operation target. Specifically, in the present disclosure, a selection target including an operation target is selected by a first operation, and an operation region corresponding to the selected selection target is set in an object such as the hand. Further, in the present disclosure, the operation target is selected by a second operation on the object in which the operation region is set. With the technology, it is possible to perform the operation on the operation target with an object (for example, a part of the body of the user) which is more easily operated. Therefore, even when the operation target is located remotely, the user can more easily select the operation target. Therefore, the selection accuracy of the operation target can be improved, and the operation burden on the user can be reduced.

The information processing system 1A according to the present embodiment will be described below in detail. Further, in the present embodiment, as will be described later, the description will proceed under the assumption that the user selects the selection target including the operation target displayed in the display region through an operation (a first operation) of holding the left hand which is an example of the first object over the display region, sets the operation region corresponding to the selection target in the left hand of the user, and performs a selection operation for the operation region set in the left hand through an operation (a second operation) by the right hand of the user which is an example of the second object.

Here, in the present embodiment, the selection target is constituted by a region including at least one operation target and can be a selection target of the first operation to be described later. In the present embodiment, an example of selecting one operation target from an operation target group including a plurality of operation targets will be described.

Further, the left hand according to the present embodiment is an example of the first object, but the first object is not limited to this example. For example, the first object may be a part of the body of the user which is an operating entity or an object which is attached to or worn on a part of the body of the user (for example, clothing, a wristband, a glove, or the like) in addition to the hand. Further, the first object may be a portable object (a sheet of paper, a board, miscellaneous goods, or the like) owned or used by the user, or a fixed object (for example, a desk, a wall, or the like) which can be touched by the user.

### <1.2. Configuration Example of Control Unit>

An example of a configuration and a function of the control unit 100 according to the first embodiment of the present disclosure will be described. FIG. 3 is a block diagram illustrating a functional configuration example of the control unit 100 according to the present embodiment. Referring to FIG. 3, the control unit 100 includes an operated position estimating unit 101, an operation recognizing unit 102, a first selecting unit 103, a setting unit 104, a second selecting unit 105, and a display control unit 106.

### (Operated Position Estimating Unit)

The operated position estimating unit 101 has a function of estimating an operated position (a pointing position in the present embodiment) in the display region 31 on the basis of the detection information generated by detecting the object by the object detecting device 20. The pointing position here means a position of a part over which the user holds the left hand in the display region 31. The operation of holding the left hand over something is an example of the first operation, and the pointing position is estimated by the first operation. An intersection point between the extension line of the arm and the left hand and the display region 31 when the user stretches out his/her arm and holds the left hand over it is the pointing position.

The operated position estimating unit 101 according to the present embodiment recognizes the position of the left hand of the user and a direction of the left hand on the basis of three-dimensional position information of the left hand generated by a depth sensor which is an example of the object detecting device 20. Further, the operated position estimating unit 101 estimates the pointing position on the basis of the recognized position and the direction of the left hand and the position of the display region 31. A known technique can be used to estimate the pointing position. For example, a technique disclosed in JP 2013-205983A may be used for estimating the pointing position. Such a pointing position can be estimated as, for example, coordinates in a plane coordinate system of the display region 31. Information related to the estimated pointing position is output to the first selecting unit 103.

Further, the pointing position according to the present embodiment is estimated on the basis of the position of the left hand held over the display region 31, but the present technology is not limited to this example. For example, the pointing position may be estimated on the basis of the form of the body of the user. The form of the body of the user includes, for example, pointing by the left hand (or the right hand), an attitude of the body of the user, the line of sight of the user, or the like in addition to the form of holding the left hand over something.

Further, in a case in which the pointing device described above is used as the object detecting device 20, a position pointed at by the pointing device may be estimated. The pointing using the pointing device is an example of the first operation. Further, in a case in which the pointing position is estimated by the pointing device, the operated position estimating unit 101 need not necessarily be installed.

Further, although the pointing position according to the present embodiment is an example of the operated position, the present technology is not limited to such an example. For example, the operated position may be an operated position specified by a gesture or the like using the hand in addition to the pointing position by the pointing operation using the hand. More specifically, a position at which at least one operation target group is located (or can be displayed) is stored in advance as a candidate of the operated position, and the operated position estimating unit 101 may estimate the operated position by a recognition result of a gesture or the like using the hand (that is, change an operation target group desired to be selected). Such a gesture is an example of the first operation and can be recognized on the basis of the detection information related to the form or the motion of the hand detected by the object detecting device 20 or the like.

### (Operation Recognizing Unit)

The operation recognizing unit 102 has a function of recognizing an operation by the user on the basis of the detection information generated by detecting the object by the object detecting device 20. Here, the recognition of the operation means recognition of a form and a motion of a part of the body of the user. For example, the operation recognizing unit 102 according to the present embodiment recognizes the operation by the user on the basis of the detection information related to the form and the motion of the hand of the user detected by the object detecting device 20. A known technique can be used to recognize such an operation. The operation by the user will be described in detail later but may include a touch operation or a proximity operation of the right hand with respect to the left hand. Further, the operation by the user may include a gesture by the left hand or the right hand. A specific example of the operation by the user will be described later.

Information related to the recognition result of the operation by the gesture of the user by the operation recognizing unit 102 is output to the first selecting unit 103 and the second selecting unit 105.

### (First Selecting Unit)

The first selecting unit 103 has a function of controlling selection of the selection target on the basis of information related to the first operation on the selection target. The first operation according to the present embodiment corresponds to the operation of holding the left hand over something (the operation using the first object), and the information related to the first operation may include, for example, the information related to the pointing position described above. The first selecting unit 103 according to the present embodiment may select the operation target group, for example, on the basis of the information related to the pointing position. More specifically, the first selecting unit 103 may select the operation target group corresponding to the pointing position in a case in which there is a pointing position within a region constituting the operation target group.

Information related to control of the selection by the first selecting unit such as the selected operation target group is output to the setting unit 104. Further, the information can be output to the display control unit 106.

Further, the first selecting unit 103 may perform control for deciding the selection of the operation target group corresponding to the pointing position on the basis of the recognition result of the operation output from the operation recognizing unit 102. In this case, information related to the operation target group which is decided to be selected can be output to the setting unit 104.

Further, as will be described in detail later, the first selecting unit 103 performs control for holding a selection state of the operation target group corresponding to the pointing position (so-called lock control) on the basis of the recognition result of the operation output from the operation recognizing unit 102. Accordingly, it is possible to prevent frequent switching of the selection of the operation target group due to shaking of the left hand. Therefore, the burden on the user in the operation can be reduced, and the operability can be further improved.

Further, in a case in which only one operation target is included in the operation target group, the first selecting unit 103 may perform control for directly selecting the operation target at this time point. Accordingly, processes by the setting unit 104 and the second selecting unit 105 to be described later can be omitted, and thus the burden related to the operation of the user can be reduced.

Further, the information related to the first operation according to the present embodiment is the information related to the pointing position, but the present technology is not limited to such an example. The information related to the first operation is not particularly limited as long as it is information related to the operated position obtained by the operated position estimating unit 101.

### (Setting Unit)

The setting unit 104 has a function of setting the operation region corresponding to the selection target selected by the first selecting unit 103 in the first object (the left hand in the present embodiment). Here, the setting of the operation region means assigning (setting) a region corresponding to at least one operation target included in the operation target group which is an example of the selection target to (in) a part of the left hand. In other words, the operation region means a region including each of regions corresponding to the operation targets allocated to respective parts of the left hand. Further, a method of setting the operation region will be described later.

The information related to the operation region set in the first object is output to the second selecting unit 105. Further, the information can be output to the display control unit 106.

### (Second Selecting Unit)

The second selecting unit 105 has a function of controlling the selection of the operation target on the basis of the information related to the second operation for the first object (left hand in the present embodiment) in which the operation region is set. Here, the second operation is an operation using the right hand which is an example of the second object in the present embodiment. In other words, the information related to the second operation may include information such as a gesture recognized by the operation recognizing unit 102 on the basis of the detection information obtained by detecting a form or a motion of the right hand. Further, the second object is not particularly limited as long as it is an object different from the first object. Further, the second operation may include, for example, a touch operation or a proximity operation on the left hand which is an example of the first object. A specific example of the second operation will be described later.

The second selecting unit 105 according to the present embodiment specifies the operation on the region corresponding to the operation target assigned to the left hand on the basis of the information related to the operation using the right hand on the left hand (that is, the recognition result of the operation by the user), and selects the operation target corresponding to such a region. In other words, the second selecting unit 105 specifies the operation (for example, touch or proximity) of the right hand on any one region assigned to the left hand on the basis of the above-described recognition result, and selects the operation target corresponding to the specified region.

Accordingly, it is possible to more reliably select the operation target in which it is difficult to select in the pointing operation. Further, as the selection control based on the operation using the body of the user such as the operation using the right hand on the left hand is performed, the user can receive tactile feedback related to the selection operation. Accordingly, it is possible to realize an operation using a somatic sensation of the human body, and for example, even when the user does not see the hand, it is possible to perform a sensory operation. Therefore, the operability can be improved.

The information related to the control of the selection by the second selecting unit 105 may be output to the display control unit 106.

### (Display Control Unit)

The display control unit 106 has a function of controlling display of selection by at least one of the first selecting unit 103 and the second selecting unit 105. The display control unit 106 according to the present embodiment controls the display of the selection for the display region 31 of the display device 30. For example, in a case in which the selection of the operation target group is decided by the first selecting unit 103, the display control unit 106 may control display of an object for presenting the operation target group which is decided to be selected. Similarly, in a case in which the operation target is selected by the second selecting unit 105, the display control unit 106 may control display of an object for presenting the selected operation target.

Further, the display control unit 106 may control display of the operation region set by the setting unit 104. For example, the display control unit 106 may control display of each region which is assigned to the left hand in association with each operation target. Accordingly, the user can check which region is allocated to which part of the left hand. Further, the display of the operation region may be performed in the display region 31 in the present embodiment but may be performed on the left hand (that is, the first object) of the user.

An example of display control by display control unit 106 will be described in detail in “Process example” and “Display control example.”

The configuration example of the control unit 100 according to the present embodiment has been described above.

### <1.3. Process Example>

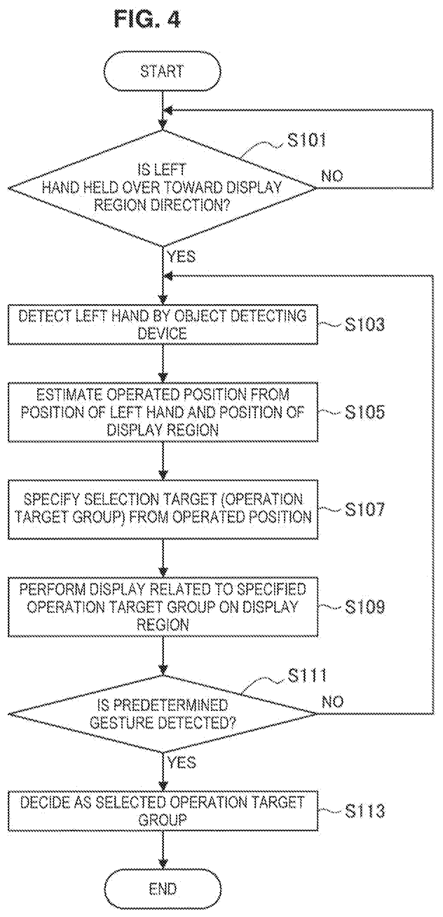

Next, a flow of a process by the information processing system 1A according to the present embodiment will be described with reference to FIG. 4 to FIG. 12.

The process by the information processing system 1A according to the present embodiment is carried out in two stages. The first stage is a process of selecting the selection target. The second stage is a process of setting the operation region corresponding to the selection target and selecting the operation target from the operation on the left hand in which the operation region is set. First, the process of the first stage by the information processing system 1A according to the present embodiment will be described with reference to FIGS. 4 to 8.

FIG. 4 is a flowchart illustrating an example of a flow of the process of the first stage by the information processing system 1A according to the present embodiment. Further, description of the above-described content for a process of each step is omitted.

Referring to FIG. 4, first, in a case in which the user holds the left hand over in the direction of the display region 31 (YES in step S101), the object detecting device 20 detects the left hand (step S103). Here, the object detecting device 20 generates the three-dimensional position information of the detected left hand as the detection information. The generated detection information is output to the control unit 100.

Then, the operated position estimating unit 101 estimates the pointing position which is the operated position on the basis of the three-dimensional position information of the left-hand included in the detection information and the position information of the display region 31 (step S105). Then, the first selecting unit 103 specifies the operation target group which is the selection target from the pointing position (step S107).

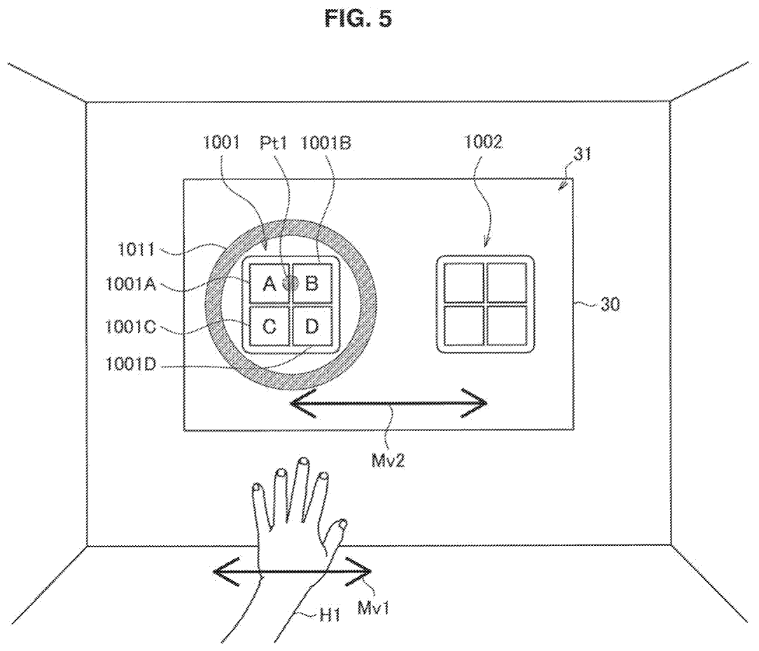

Then, the display control unit 106 performs display related to the specified operation target group in the display region 31 (step S109). Here, an example of the display related to the operation target group by the display control unit 106 will be described with reference to FIGS. 5 to 8.

FIG. 5 is a diagram for describing a first example of the display control by the display control unit 106 according to the present embodiment. As illustrated in FIG. 5, the display device 30 is arranged on the wall portion of the space 2 in which the user U1 is located, and selection target objects 1001 and 1002 each including four operation target objects are displayed in the display region 31 of the display device 30. Further, for example, the selection target object 1001 includes operation target objects 1001A to 1001D.

Referring to FIG. 5, the user U1 holds a left hand H1 over toward the selection target object 1001 of the display region 31 which is located remotely. The operated position estimating unit 101 estimates a pointing position Pt1 corresponding to the left hand H1 which is held over, and the first selecting unit 103 selects the selection target object 1001 since the pointing position PO is included in the region constituting the selection target object 1001. Since the region constituting the selection target object 1001 is larger than the operation target objects 1001A to 1001D, the pointing operation of the left hand H1 by the user U1 can be easily performed. Then, the display control unit 106 may display a ring-like object 1011 around the selection target object 1001 to indicate that the selection target object 1001 is selected. Accordingly, the user U1 can recognize that the selection target object 1001 is selected.

Further, as illustrated in FIG. 5, in a case in which the left hand H1 is moved in a direction of an arrow Mv1, the pointing position Pt1 also changes. Accordingly, for example, the ring-like object 1011 may move along an arrow Mv2 and be displayed around the selection target object 1002. Further, even after the selection of the selection target object 1002 is decided in step S113 to be described later, the display control unit 106 may hold a state in which the ring-like object 1011 is displayed. Accordingly, the user can continuously receive feedback for the selection target object selected by the user.

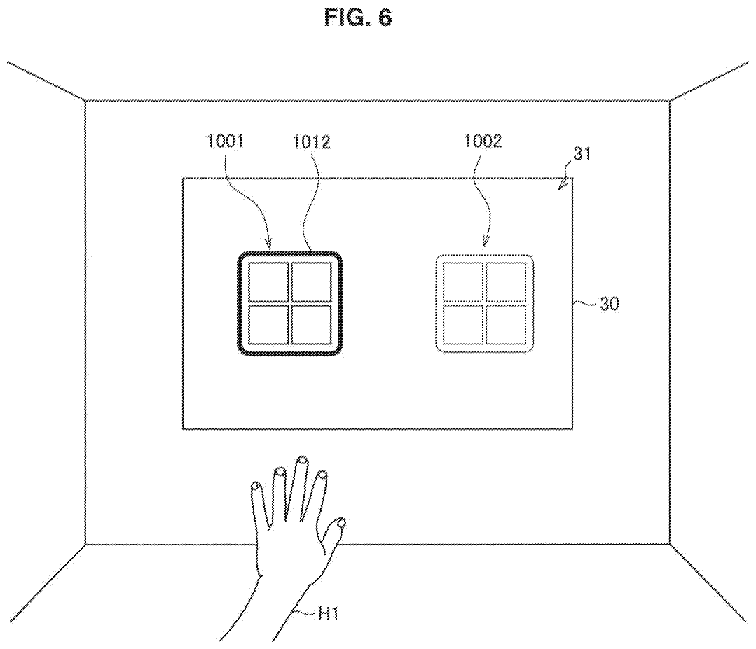

FIG. 6 is a diagram for describing a second example of the display control by the display control unit 106 according to the present embodiment. As illustrated in FIG. 6, in a case in which the selection target object 1001 is selected on the basis of the operation of the left hand H1 of the user U1, the display control unit 106 may cause another selection target object (for example, the selection target object 1002) to be blurred or transparent and display the selection target object 1001. Further, at this time, the display control unit 106 may highlight a contour portion 1012 of the selected selection target object 1001.

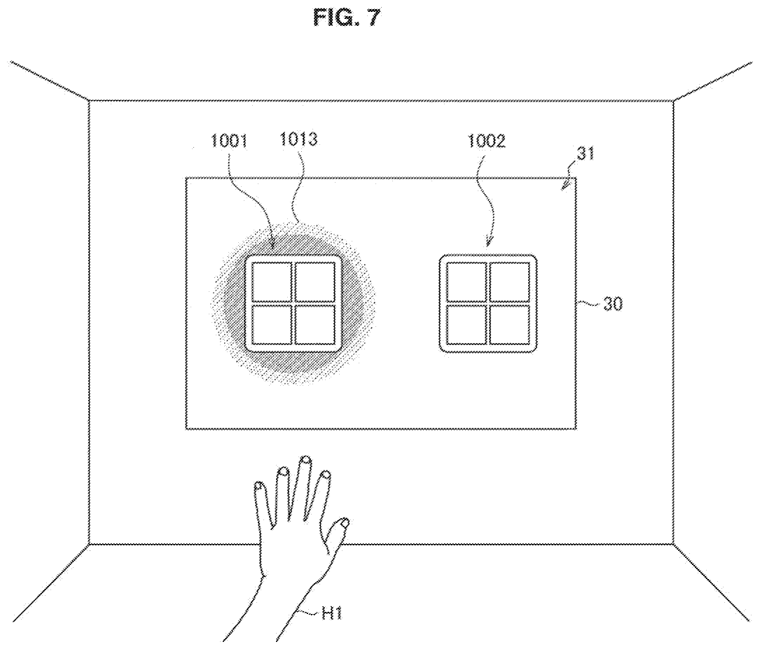

FIG. 7 is a diagram for describing a third example of the display control by the display control unit 106 according to the present embodiment. As illustrated in FIG. 7, in a case in which the selection target object 1001 is selected on the basis of the operation of the left hand H1 of the user U1, the display control unit 106 may display the selection target object 1001 and the periphery thereof with a highlight 1013.

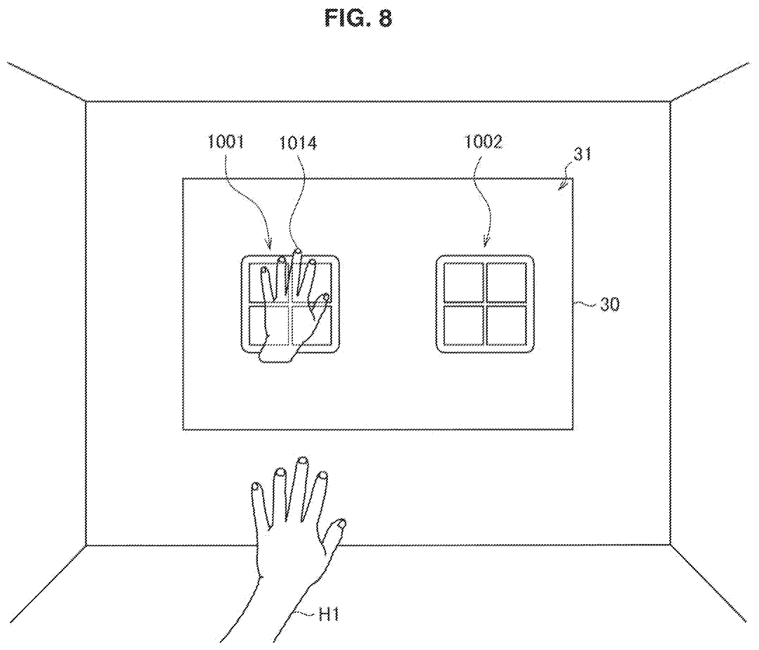

FIG. 8 is a diagram for describing a fourth example of the display control by the display control unit 106 according to the present embodiment. As illustrated in FIG. 8, in a case in which the selection target object 1001 is selected on the basis of the operation of the left hand H1 of the user U1, the display control unit 106 may cause an object 1014 imitating the hand to be superimposed on the selected selection target object 1001.

The example of the display control by the display control unit 106 is not limited to the examples illustrated in FIGS. 5 to 8. The display form is not particularly limited as long as it is possible to present the selected selection target object to the user. Further, in the present embodiment, the display control unit 106 performs display control for presenting the selected selection target object, but the present technology is not limited to such an example. For example, in a case in which the selection target is a region including a switch or the like installed on the wall or the like of the space 2 in which the user U1 is located, when the region is selected, a light source or the like installed in the space 2 may illuminate the region. Accordingly, the user U1 can recognize that the region is selected.

The process example of the first stage of the information processing system 1A will be described with reference back to FIG. 4. It is determined whether or not a predetermined gesture is detected in the state where the operation target group is selected (step S111). In a case in which a predetermined gesture is detected (YES in step S111), the first selecting unit 103 decides the selection of the operation target group (step S113). The predetermined gesture may be a gesture recognized on the basis of the detection information acquired by the operation recognizing unit 102.

Here, the predetermined gesture may be, for example, a gesture by the left hand, a gesture by the right hand, or a gesture using a part of the body. Specifically, the predetermined gesture may be a motion of closing and clenching the left hand which is held over, a motion of tapping the left hand which is held with the right hand. Further, in the present embodiment, the selection of the selection target is decided by detecting a predetermined gesture, but the present technology is not limited to this example. For example, the selection of the selection target is decided on the basis of an operation using a physical switch such as a toggle switch of a remote controller connected to the network NW illustrated in FIG. 1, an operation by a voice command using a voice input device and a voice processing device, or the like. Further, the selection of the selection target may be decided when the state in which the selection target is being selected by the first selecting unit 103 continues for a predetermined period of time. In other words, the decision of the selection of the selection target can be performed by any operation detectable by known sensing techniques.

If the selection of the selection target is decided, the process of the first stage of the information processing system 1A according to the present embodiment ends. In the process of the first stage, since the selection target including the operation target can be constituted by a region larger than the operation target, the pointing by the operation such as the gesture of the user is easy. Therefore, even when the operation target is not selected directly in the first stage, the operation region corresponding to the selection target including the operation target is set in the left hand in the second stage to be described later. Therefore, it is possible to reliably select the operation target in the second stage to be described below.

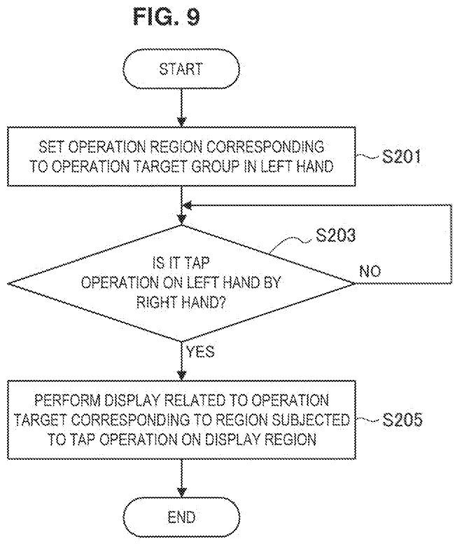

Next, the process of the second stage by the information processing system 1A according to the present embodiment will be described with reference to FIGS. 9 to 12.

FIG. 9 is a flowchart illustrating an example of a flow of the process of the second stage by the information processing system 1A according to the present embodiment. Further, description of the above-described content for a process of each step is omitted is omitted.

Referring to FIG. 9, the setting unit 104 first sets the operation region corresponding to the operation target group in the left hand (step S201).

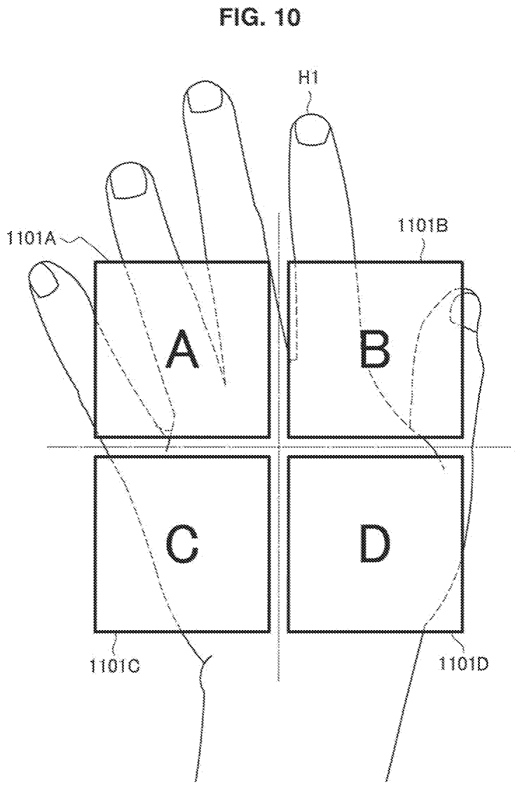

FIG. 10 is a diagram illustrating an example of setting the operation region by the setting unit 104 according to the present embodiment. As illustrated in FIG. 10, an operation region 1101 is set in the left hand H1. Specifically, regions 1101A to 1101D are regions corresponding to the operation target objects 1001A to 1001D, respectively, and the regions 1101A to 1101D are allocated to the upper left, the upper right, the lower left, and the lower right of the back of the left hand H1. The regions 1101A to 1101D may be displayed on the back of the left hand H1 by a predetermined projection device or the like or may be displayed in the display region 31 as will be described later specifically. Accordingly, the user U1 can recognize a portion of the left hand H1 which is a desired operation target.

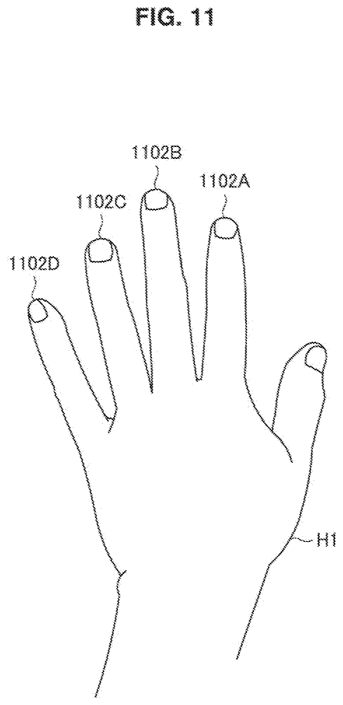

Further, the setting of the operation region by the setting unit 104 is not limited to the example illustrated in FIG. 10. FIG. 11 is a diagram illustrating another example of setting the operation region. As illustrated in 11, the setting unit 104 may set, for example, regions 1102A to 1102D corresponding to the operation target objects 1001A to 1001D in the index finger, the middle finger, the ring finger, and the little finger of the left hand H1 of the user U1. In this case, the selection by the second selecting unit 105 to be described later is controlled on the basis of information related to the operation of tapping the finger corresponding to the operation target with the right hand or information related to a motion of folding a finger corresponding to the operation target or the like. Since each finger is independent, the accuracy of the selection control by the second selecting unit 105 can be improved.

The process example of the second stage of the information processing system 1A will be described with reference back to FIG. 9. Then, the second selecting unit 105 controls the selection of the operation target on the basis of information related to the tap operation on the left hand by the right hand based on the recognition result by the operation recognizing unit 102 (step S203). Here, in a case in which there is a tap operation on the left hand by the right hand (YES in step S203), the second selecting unit 105 selects the operation target corresponding to the region including the tapped part of the left hand.

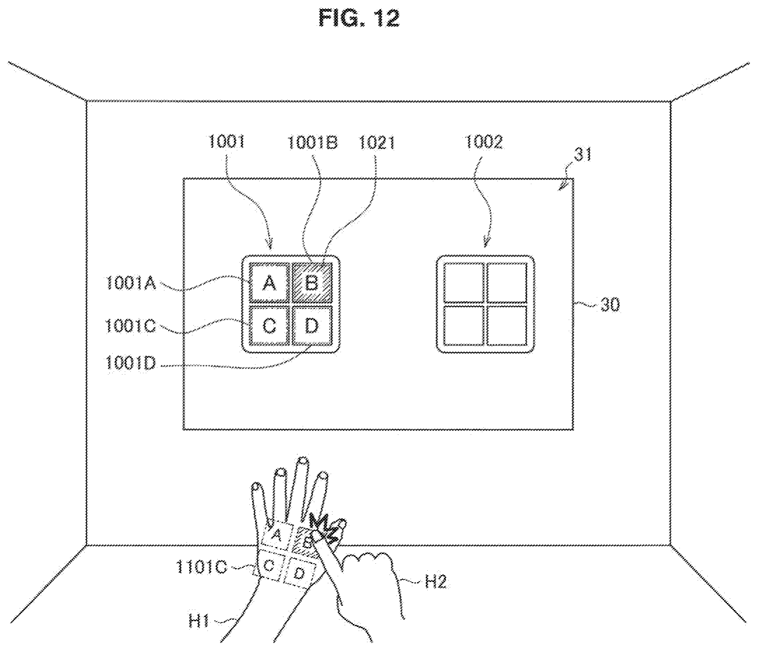

Then, the display control unit 106 performs display related to the selected operation target in the display region 31 (step S205). Here, an example of the display related to the selected operation target by the display control unit 106 will be described with reference to FIG. 12.

FIG. 12 is a diagram for describing an example of the display control by the display control unit 106 according to the present embodiment. As illustrated in FIG. 12, the operation region 1101 corresponding to the selected selection target object 1001 is set in the left hand H1 of the user U1, and regions 1101A to 1101D corresponding to the operation target objects 1001A to 1001D are allocated in the left hand H1.

The user U1 is assumed to perform the tap operation on the region 1101B allocated to the left hand H1 using a right hand H2. In this case, the operation target object 1001B corresponding to the region 1101B is selected by the second selecting unit 105 on the basis of information related to the tap operation. At this time, the display control unit 106 may highlight the operation target object 1001B with a highlight 1021 to indicate that the operation target object 1001B is selected. Accordingly, the user U1 can recognize that the operation target object 1001B is selected.

Further, similarly to the display control in the process example of the first stage illustrated in FIGS. 5 to 8, even in the process of the second stage, the display form is not particularly limited as long as it is possible to present the selected operation target object to the user. Further, in the present embodiment, the display control unit 106 performs the display control for presenting the selected operation target object, but the present technology is not limited to such an example. For example, in a case in which the operation target is a switch or the like installed on the wall or the like of the space 2 in which the user is located, when the switch or the like is selected, a light source or the like installed in the space 2 may illuminate the switch or the like. Accordingly, the user can recognize that the switch or the like is selected.

The process example of the second stage of the information processing system 1A according to the present embodiment has been described above. In the information processing system 1A according to the present embodiment, in the first stage, the selection target including the operation target can be selected, and in the second stage, the operation target can be selected by the operation on the left hand in which the operation region corresponding to the selection target is set. As described above, the operation target which is located remotely is selected by hand or the like, and thus it is possible to more reliably select the operation target which is located remotely and reduce the burden on the body related to the remote control of the user. Therefore, the user can more easily select the operation target. Further, the operation target and the selection target according to the present embodiment are assumed to be located remotely from the user, but the present technology is not limited to such an example. For example, the present system is also applicable to an operation target and a selection target which the user can touch directly. More specifically, in a case in which the selection target is installed in a wall body, when the user touches the selection target by the left hand, the operation region corresponding to the selection target may be set in the left hand by the setting unit 104. Accordingly, the user can move away from the selection target while holding the operation region on the left hand.

### <1.4. Modified Example>

Next, a modified example of the process in the information processing system 1A according to the present embodiment will be described.

### (1. Lock Control)

In the process of the first stage, the first selecting unit 103 performs control (so-called lock control) for holding the selection state of the operation target group corresponding to the pointing position on the basis of a recognition result of an operation (third operation) output from the operation recognizing unit 102. Accordingly, it is possible to prevent the frequent switching of the selection of the operation target group by shaking of the left hand. Therefore, the burden on the user in the operation can be reduced. The flow of the lock process will be specifically described below.

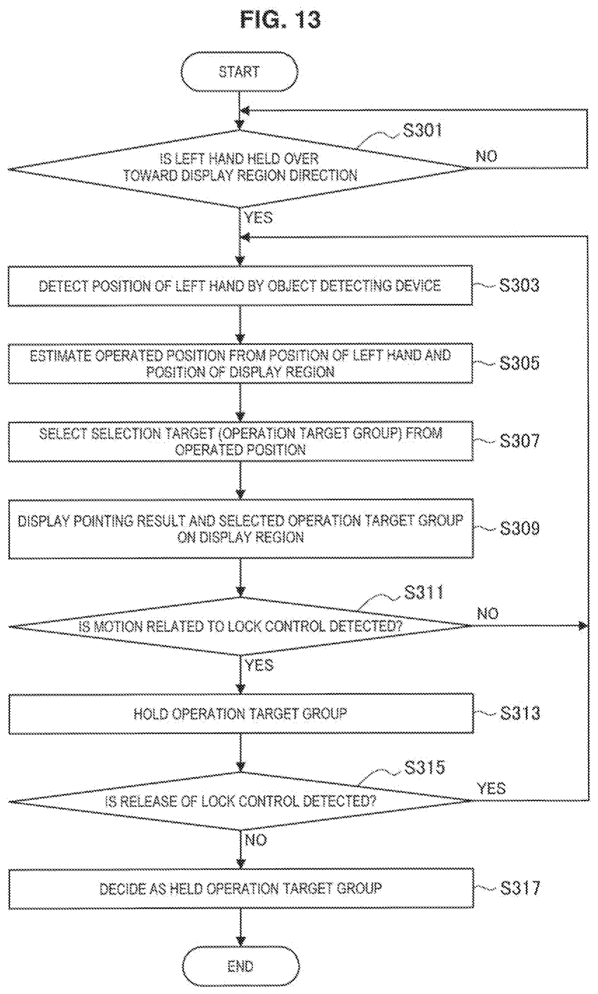

FIG. 13 is a flowchart illustrating the flow of a process of the first stage in accordance with the first modified example of the information processing system 1A according to the present embodiment.

Referring to FIG. 13, first, in a case in which the user holds the left hand over toward the direction of the display region 31 (YES step S301), the object detecting device 20 detects the left hand (step S303). Here, the object detecting device 20 generates the three-dimensional position information of the detected left hand as the detection information. The generated detection information is output to the control unit 100.

Then, the operated position estimating unit 101 estimates the pointing position which is the operated position on the basis of the three-dimensional position information of the left-hand included in the detection information and the position information of the display region 31 (step S305). Then, the first selecting unit 103 specifies the operation target group which is the selection target from the pointing position (step S307). Then, the display control unit 106 performs the display related to the specified operation target group in the display region 31 (step S309).

Then, in the state in which the operation target group is selected, it is determined whether or not a predetermined operation (third operation) related to the lock control is detected (step S311). In a case in which a predetermined operation is detected (YES in step S311), the first selecting unit 103 performs the lock control for holding the state in which the operation target group is selected (step S313). Accordingly, for example, even in a case in which the pointing position deviates from the region constituting the operation target group, the operation target group is continuously in the selected state. Therefore, since the user need not maintain the pointing position continuously, the burden on the user decreases.

Then, in a case in which the state in which the operation target group is selected is held, it is determined whether or not a release operation (fourth operation) of the lock control is detected (step S315). In a case in which the release operation of the lock control is detected (YES in step S315), the first selecting unit 103 releases the lock control, and the process of step S303 is performed again. On the other hand, in a case in which the release operation of the lock control is not detected (NO in step S315), the first selecting unit 103 decides the selection of the operation target group (step S317).

Further, for example, operations shown illustrated in Table 1 below are included in the third operation which is the operation related to the lock control and the fourth operation which is the release operation of the lock control. For example, an operation of pinching with the fingers of the right hand in a case in which the left hand is held over the display region 31, an operation using a physical switch such as a toggle switch of a remote controller connected to the network NW illustrated in FIG. 1, an operation by a voice command using a voice input device and a voice processing device, an operation by a motion such as head nodding or head swing detected by a depth sensor, an acceleration sensor, or the like, and the like can be included in the operation related to the lock control and the release operation of the lock control. Further, in a case in which the operation on the left hand (so-called second operation) is not performed for a certain period of time after the operation of the lock control is performed, the first selecting unit 103 may release the lock control.

TABLE 1

| Operations related lock control | Release operations of lock control |
|---|---|
| Gesture by left hand which is held over | Gesture by left hand which is held over |
| (clenching operation) | (opening operation) |
| Gesture by right hand which is not held | Gesture by right hand which is not held |
| over (operation of pinching with fingers) | over (operation of pinching with fingers) |
| Push physical button of remote controller | Push physical button of remote controller |
| Head nodding motion | Head swing motion |
| Voice command such as “lock” | Voice command such as “lock release” |
| | Lapse of Predetermined period of time |
| | without motion |
| | Leave of user from operation space |

Further, the operation related to the lock control and release operation corresponding thereto are described in each row of Table 1, but each operation need not be associated necessarily. For example, the operation related to the lock control may be an operation using the right hand, and the operation of releasing the lock control may be an operation using the head. Further, the lock control is not limited to control which is performed on the basis of a recognition result of a gesture or the like by the operation recognizing unit 102 but may be performed on the basis of a detection result of a gesture or the like detected by another sensor (not illustrated). Further, each operation illustrated in Table 1 is merely an example, and it is not particularly limited as long as it is an operation which can be detected by a known sensing technique.

### (2. Modified Example of Operation Target and Display of Operation Region)

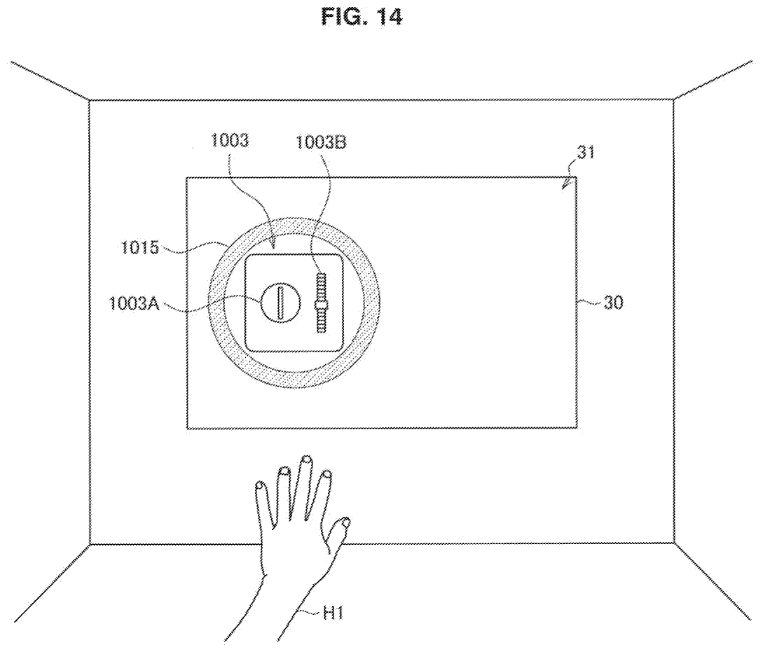

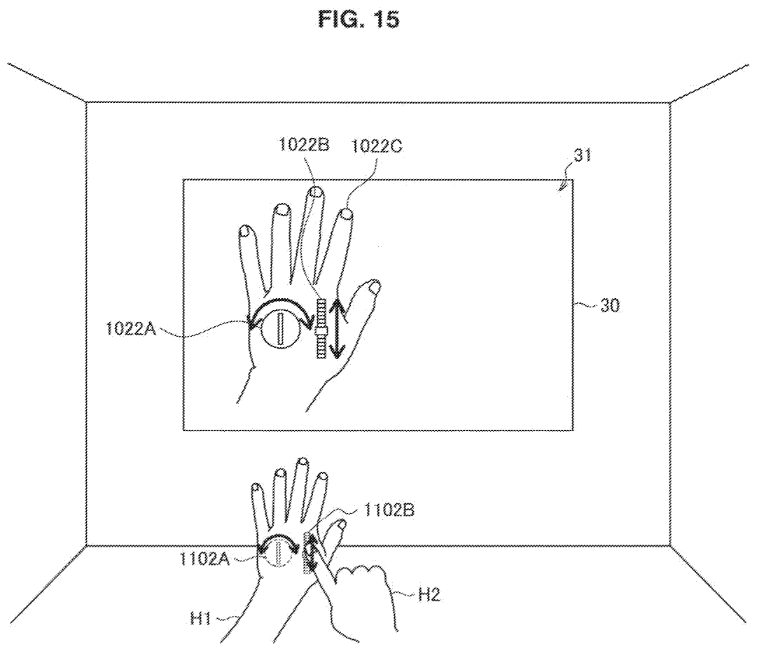

FIGS. 14 and 15 are diagrams illustrating a control example related to a second modified example of the information processing system 1A according to the present embodiment. First, referring to FIG. 14, a selection target object 1003 is displayed in the display region 31. The selection target object 1003 includes a selector switch object 1003A and a slider object 1003B. In other words, in the present modified example, an example in which not only the operation target is simply selected by the second operation, but also the state of the operation target can be changed at the same time as when the operation target is selected by the second operation will be described.

As illustrated in FIG. 14, the first selecting unit 103 is assumed to select the selection target object 1003 on the basis of the information related to the operation of the user U1 of holding the left hand H1 over toward the display region 31. At this time, a ring-like object 1015 may be displayed around the selection target object 1003 to indicate that selection target object 1003 is selected.

Then, the setting unit 104 sets an operation region 1102 corresponding to the selection target object 1003 in the back of the left hand H1 of the user U1. In other words, the setting unit 104 assigns regions corresponding to the selector switch object 1003A and the slider object 1003B to the back of the left hand H1. In this case, as illustrated in FIG. 15, regions 1102A and 1102B are allocated to the back of the left hand H1, respectively. The regions 1102 A and 1102 B are not displayed on the back of the left hand H1. Therefore, it is difficult to operate the selector switch object 1003A and the slider object 1003B by right hand H2 in this state.

In this regard, the display control unit 106 may control the display related to the setting state of the operation region 1102 in the left hand H1. Specifically, as illustrated in FIG. 15, the display control unit 106 may display a selector switch object 1022A and a slider object 1022B as the display corresponding to the regions 1102A and 1102B and further display a left hand object 1022C corresponding to the left hand H1 in the display region 31. At this time, the selector switch object 1022A and the slider object 1022B may be displayed on the left hand object 1022C to correspond to the assignment positions of the regions 1102A and 1102B assigned to the back of the left hand H1. Accordingly, the user U1 can perform an operation while checking an operation target being operated and a degree of operation. Further, the display control unit 106 may further control display or the like for a position at which the right hand H2 touches the left hand H1 and a degree of operation of the operation target. In this case, since the user U1 can receive feedback for the operation, the operation is easier.

Further, although the selector switch and the slider have been described as the modified example of the operation target, the operation target is not limited to this example. As long as it is a display form in which an input based on the operation of the user is accepted, a shape, a size, a position, a type, and the like of the operation target are not particularly limited. Further, in the present modified example, the display of the selector switch object 1003A and the slider object 1003B which are the operation targets is different from the display of the selector switch object 1022A and the slider object 1022B corresponding to the operation region, but these displays may be identical to each other. In other words, the display of the selector switch object 1003A and the slider object 1003B which are the operation targets may be directly controlled as the display of the selector switch object 1022A and the slider object 1022B corresponding to the operation region.

### (3. Drawable Object)

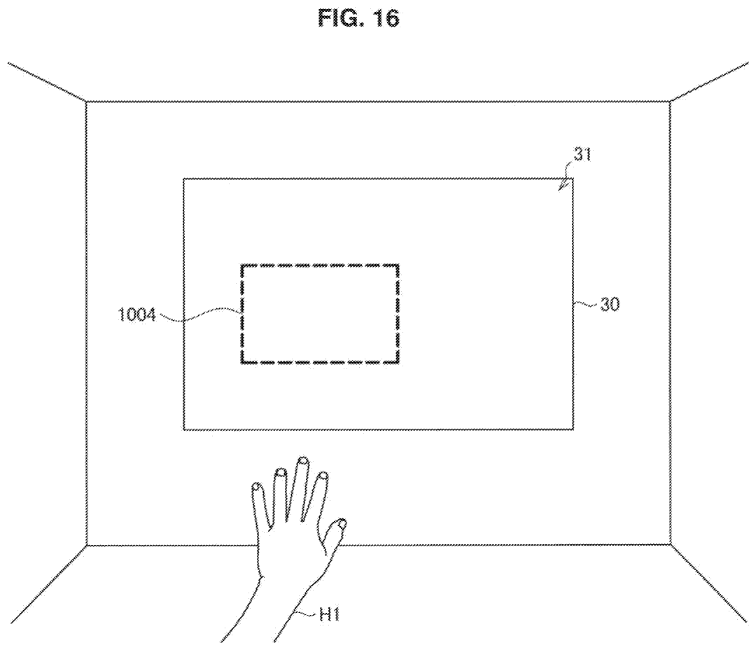

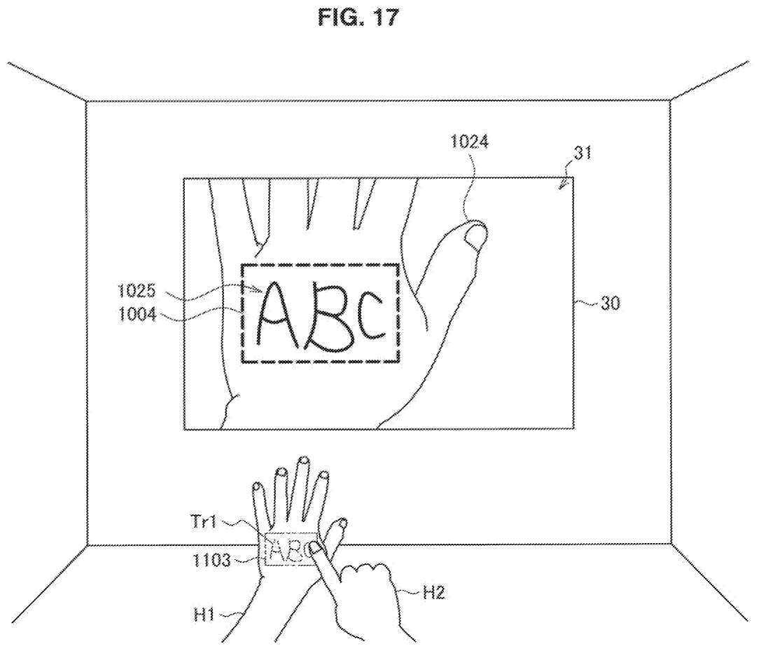

FIGS. 16 and 17 are diagrams illustrating an example of control according to a third modified example of the information processing system 1A according to the present embodiment. Referring to FIG. 16, a selection target object 1004 is displayed in the display region 31. The selection target object 1004 is an object indicating a drawable range and indicates a range in which an object such as a character or an illustration can be drawn by the operation of the user U1. In this case, the operation target is a unit pixel included in a region constituting the selection target object 1004. For example, a position, a size, and a shape of the selection target object 1004 may be specified by a gesture or the like using the right hand H2 in addition to the left hand H1.

As illustrated in FIG. 16, the first selecting unit 103 is assumed to select the selection target object 1004 on the basis of the information related to the operation of the user U1 of holding the left hand H1 over toward the display region 31. In this case, the setting unit 104 sets an operation region 1103 in the back of the left hand H1 of the user U1. Further, the operation region 1103 may be set in the palm of the left hand H1. Such an operation region 1103 serves as a drawing canvas. However, as described in the second modified example, since the operation region 1103 is not displayed on the back of the left hand H1 of the user U1, it is difficult for the user U1 to recognize the operation region 1103 which is the drawing canvas.

In this regard, the display control unit 106 may control the display related to the setting state of the operation region 1103 in the left hand H1. Specifically, as illustrated in FIG. 17, the display control unit 106 may display a left hand object 1024 corresponding to the back of the left hand H1 of the user U1 in the display region 31 together with a selection target object 1004. At this time, the left hand object 1024 can be displayed so that the selection target object 1004 is positioned corresponding to the position of the operation region 1103 in the back of the left hand H1. Accordingly, the user U1 can draw a character Tr1 or the like on the selection target object 1004 using the right hand H2 while viewing the display region 31. A character object 1025 corresponding to the character Tr1 can be displayed in the display region 31.

Further, in the second modified example and the third modified example, it is assumed that the object corresponding to the left hand H1 can be displayed in the display region 31, but the present technology is not limited to this example. In other words, at the time of the second operation, control for displaying the object corresponding to the left hand H1 (first object) in the display region 31 may not be performed.

### (4. Hover Operation)

In the process of the second stage of the information processing system 1A described above, the second selecting unit 105 controls the selection of the operation target on the basis of the information related to the touch operation such as the tap operation of the right hand on the left hand, but the present technology is not limited to such an example. For example, the second selecting unit 105 may control the selection of the operation target on the basis of the information related to a proximity operation such as a hover operation. For example, information related to the proximity operation may be obtained on the basis of a recognition result by the operation recognizing unit 102.

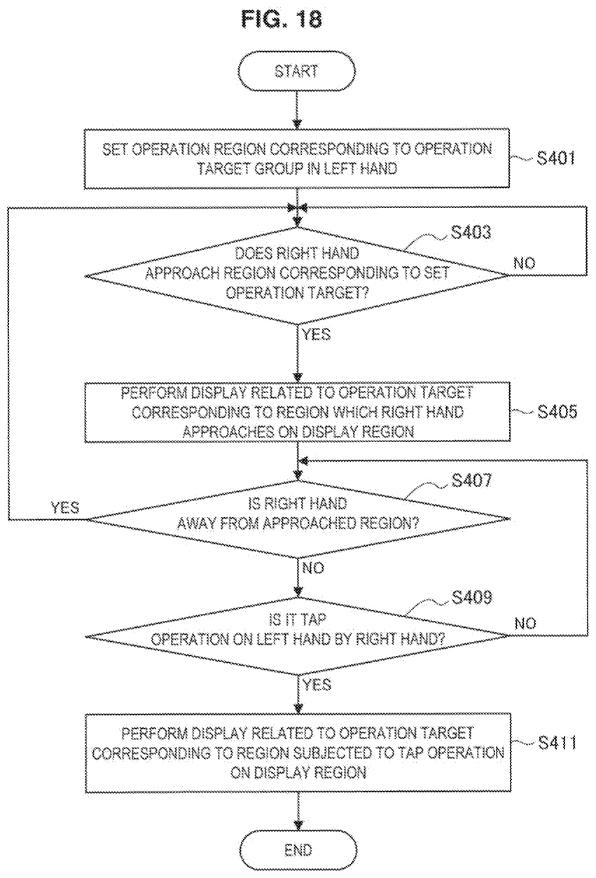

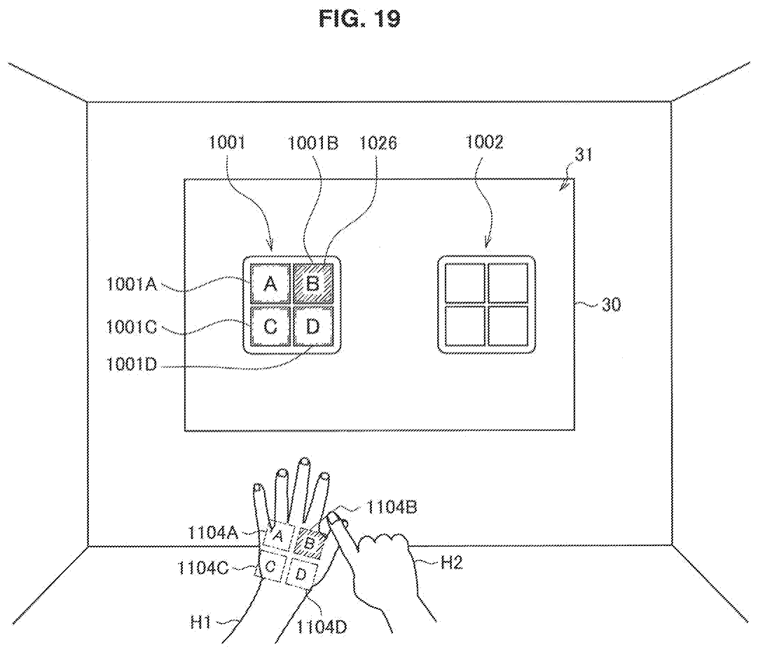

FIG. 18 is a flowchart illustrating a flow of a process of a second stage according to a fourth modified example of the information processing system 1A according to the present embodiment. Further, FIG. 19 is a diagram illustrating a control example related to the fourth modified example of the information processing system 1A according to the present embodiment. Here, description will proceed in accordance with the flowchart illustrated in FIG. 18.

First, the setting unit 104 sets the operation region corresponding to the operation target group in the left hand (step S401). Then, it is determined whether or not the approach of the right hand (that is, the hover operation) to the region corresponding to the operation target assigned to the left hand is detected (step S403). In a case in which the approach of the right hand to the region is detected (YES in step S403), the second selecting unit 105 selects the operation target corresponding to the approached region. Then, the display control unit 106 controls display related to the operation target corresponding to the approached region (step S405).

As illustrated in FIG. 19, an operation region 1104 corresponding to the selected selection target object 1001 is set in the left hand H1 of the user U1, and regions 1104A to 1104D corresponding to the operation target objects 1001A to 1001D are allocated in the left hand H1.

The user U1 causes the finger of the right hand H2 to approach the region 1101B assigned to the left hand H1 (hover operation). In this case, the second selecting unit 105 specifies the operation target object 1001B corresponding to the region 1101B on the basis of information related to the hover operation. At this time, since the display control unit 106 can cause a highlight 1026 to be displayed on the operation target object 1001B in order to indicate that the operation target object 1001B is specified by the hover operation. Accordingly, the user U1 can recognize that the operation target object 1001B is specified by the hover operation.

Then, it is determined whether or not it is detected that the right hand H2 is away from the region which it has approached once (step S407). Here, in a case in which it is not detected that the right hand H2 is away from the region which it has approached once (NO in step S407), the second selecting unit 105 controls the selection of the operation target on the basis of information related to the tap operation of the right hand H2 on the left hand H1 based on the recognition result by the operation recognizing unit 102 (step S409). Here, in a case in which there is a tap operation of the right hand H2 on the left hand H1 (YES in step S409), the second selecting unit 105 selects the operation target corresponding to the region including a tapped part of the left hand H1. Then, the display control unit 106 displays display related to the selected operation target in the display region 31 (step S411).

As described above, since the feedback of the display in the case of approaching the region corresponding to the operation target by the hover operation is given, it is possible to more reliably perform an operation of selecting a desired operation target.

Further, the second operation according to the present embodiment may include the touch operation and the proximity operation. The touch operation may include, for example, a turning operation, a slide operation, a flick operation, a drag operation, a pinch operation, a knob operation, and the like. Further, the proximity operation may include a gesture using a finger nearby the first object such as the left hand in addition to the hover operation. Further, in the present embodiment, the second operation is the operation by the right hand, but the present technology is not limited to such an example. For example, the second operation may be an operation by a part of the body other than the right hand or an operation by another device such as a remote controller. As the second operation is performed by the right hand, it is possible to perform an operation using a somatic sensation of the body. Accordingly, the operability can be improved.

The first embodiment of the present disclosure has been described above.

### 2. Second Embodiment

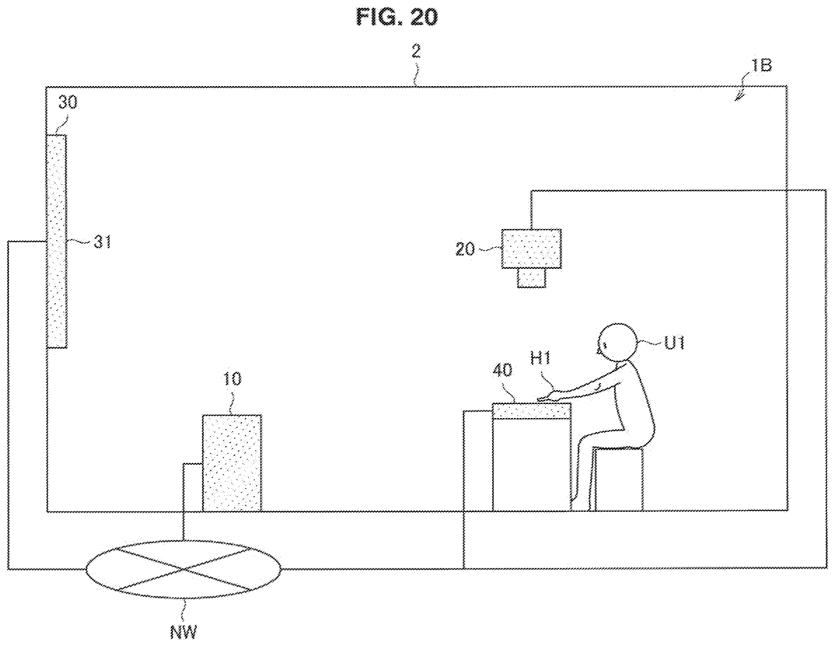

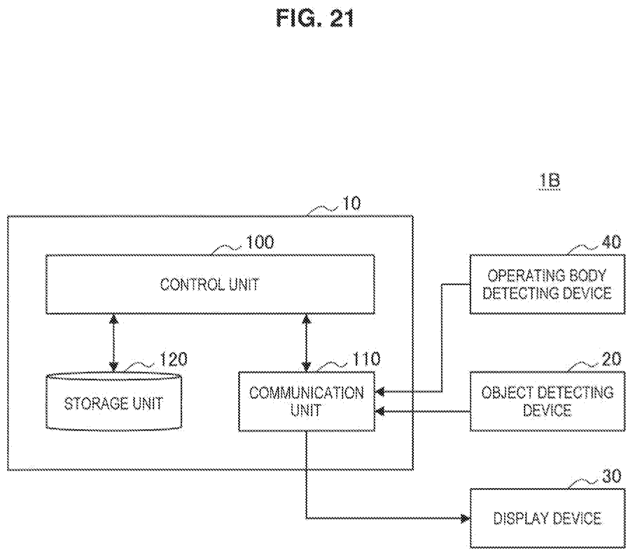

Next, a second embodiment of the present disclosure will be described. FIGS. 20 and 21 are diagrams illustrating an overview and a configuration example of an information processing system 1B according to a second embodiment of the present disclosure. As illustrated in FIG. 20, the information processing system 1B according to the present embodiment includes an operating body detecting device 40 in addition to the information processing device 10, the object detecting device 20, and the display device 30. Since configurations and functions of the respective device except the operating body detecting device 40 are identical to those of the first embodiment, description thereof is omitted.

### (Operating Body Detecting Device)

The operating body detecting device 40 is an example of a detecting device used for detecting the operating body. The operating body detecting device 40 according to the present embodiment generates operating body detection information related to a hand H1 of the user U1 which is an example of the operating body. The generated operating body detection information is output to the information processing device 10 via the network NW (or directly). Further, as illustrated in FIG. 20, for example, the operating body detecting device 40 according to the present embodiment detects the hand H1 which can be positioned above the operating body detecting device 40 installed on a workbench.

The operating body detection information includes, for example, information related to a position of the detected operating body in (a local coordinate system or a global coordinate system of) a three-dimensional space. In the present embodiment, the operating body detection information includes information related to the position of the operating body in a coordinate system of the space 2. Further, the operating body detection information may include a model or the like generated on the basis of a shape of the operating body. As described above, the operating body detecting device 40 acquires information related to an operation which the user U1 performs on the operating body detecting device 40 as the operating body detection information.

The operating body detecting device 40 according to the present embodiment can be realized by an infrared irradiation light source, an infrared camera, and the like. Further, the operating body detecting device 40 may be realized by any of various types of sensors such as a depth sensor, a camera, a magnetic sensor, and a microphone. In other words, the operating body detecting device 40 is not particularly limited as long as it can acquire a position, a form, and/or the like of the operating body.

Further, in the example illustrated in FIG. 20, the operating body detecting device 40 is described as being placed on the workbench, but the present technology is not limited to such an example. For example, in another embodiment, the operating body detecting device 40 may be a device held by a hand which is an operating body or a wearable device which is attached to a wrist, an arm or the like. Various types of inertial sensors or mechanical sensors such as a gyro sensor, a potentiometer, and an encoder are installed in such a wearable device, and a position or the like of a hand which is the operating body may be detected by each sensor. Further, in another embodiment, a marker may be installed on the hand H1 of the user U1, and the operating body detecting device 40 may detect the position or the like of the hand H1 by recognizing such a marker. Further, the operating body detecting device 40 may be a device which generates the operating body detection information using a touch of a hand H1 as an input such as a touch panel.

The operating body detection information generated by the operating body detecting device 40 is transmitted to the information processing device 10. The control unit 100 acquires the operating body detection information via the communication unit 110. The operated position estimating unit 101 according to the present embodiment estimates the operated position on the basis of the operating body detection information. Since the details of the estimation processing are similar to those of the first embodiment, description thereof is omitted.

As described above, the operated position such as the pointing position is detected by the operating body detecting device 40 according to the present embodiment, and thus it is possible to more certainly specify the operated position. Further, since the operating body detecting device 40 according to the present embodiment is installed on the workbench, an operation can be performed without causing the hand H1 to float. Therefore, the burden of the operation of the hand H1 by the user U1 can be reduced.

The second embodiment of the present disclosure has been described above.

### 3. Third Embodiment

### <3.1. Overview of Information Processing System>

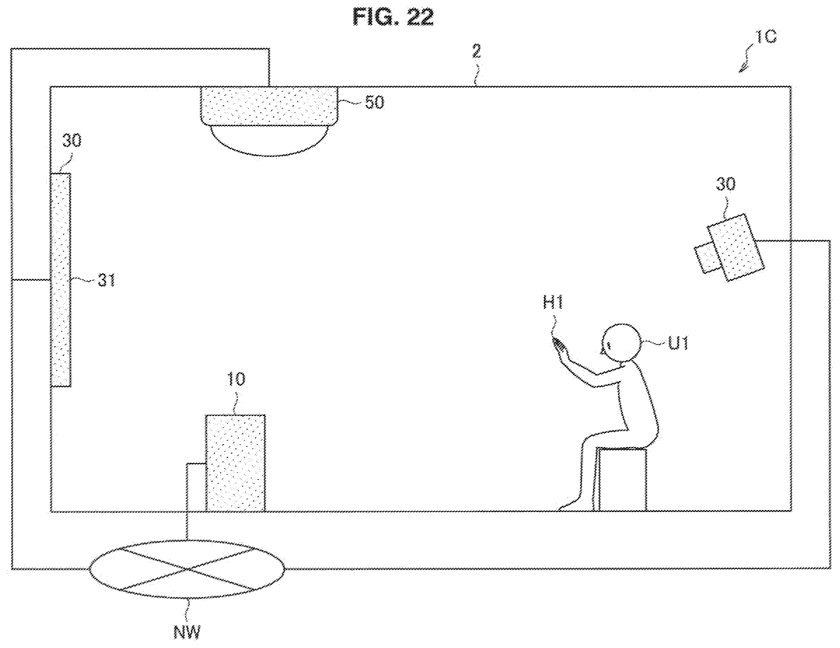

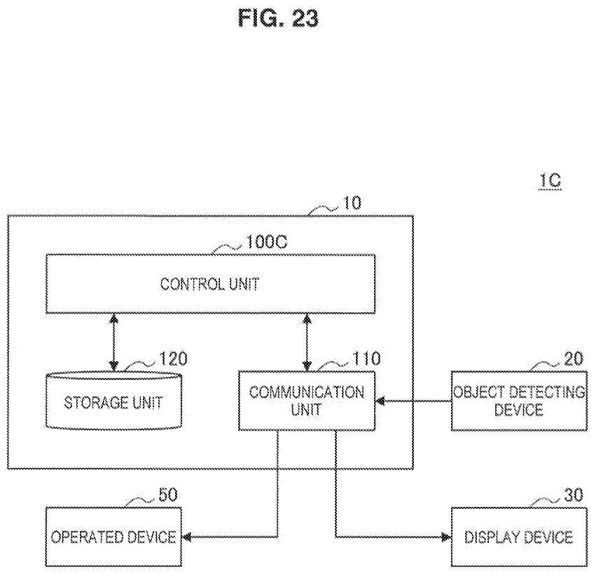

Next, a third embodiment of the present disclosure will be described. FIGS. 22 and 23 are diagrams illustrating an overview and a configuration example of an information processing system 1C in accordance with the third embodiment of the present disclosure. As illustrated in FIG. 22, the information processing system 1C according to the present embodiment includes an operated device 50 in addition to the information processing device 10, the object detecting device 20, and the display device 30. Since configurations and functions of the respective devices except the operated device 50 are identical to those of the first embodiment, description thereof is omitted.

### (Operated Device)

The operated device 50 is a device controlled by an operation on the operation target selected by the user U1. In FIG. 22, a lighting device is illustrated as an example of the operated device 50. The operated device 50 includes home electric appliances such as an air conditioner, a television, a refrigerator, a washing machine, and an audio device and devices related to buildings such as a lighting device, a locking device, and an intercom. In other words, the operated device 50 may include all devices installed in the space 2 to which the information processing system 1C according to the present embodiment is applied.

As illustrated in FIGS. 22 and 23, the operated device 50 is connected to the information processing device 10 via a network NW in a wired or wireless manner. The operated device 50 is controlled on the basis of an output signal acquired from the information processing device 10 via the network NW (or directly).

### <3.2. Configuration Example of Configuration Unit>

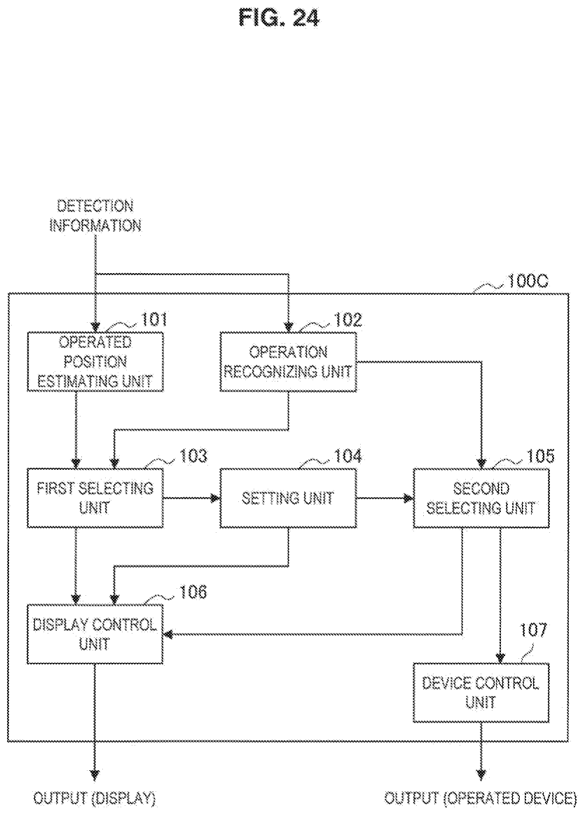

FIG. 24 is a block diagram illustrating a functional configuration example of the control unit 100C according to the present embodiment. Referring to FIG. 24, the control unit 100C further includes a device control unit 107 in addition to the operated position estimating unit 101, the operation recognizing unit 102, the first selecting unit 103, the setting unit 104, the second selecting unit 105, and the display control unit 106. Further, configurations of the functional units except the device control unit 107 and functions of the respective functional units are identical to those of the respective functional units according to the first embodiment, and thus description thereof is omitted.

### (Device Control Unit)

The device control unit 107 has a function of controlling the operated device 50 corresponding to the operation target selected by the second selecting unit 105. For example, in a case in which the operation target is a switch, and the switch is selected by the second selecting unit 105, the device control unit 107 performs control related to switching of the switch for the operated device 50 corresponding to the switch. In a case in which the operated device 50 is a lighting device illustrated in FIG. 22, the device control unit 107 may control switching of lighting of the lighting device.

Further, in a case in which the state of the operation target can be changed at the same time as the selection of the operation target by the second operation like the selector switch object 1003A or the slider object 1003B illustrated in FIG. 14, the device control unit 107 may generate an output signal for controlling the operated device 50 on the basis of the changed state of the operation target. For example, when the switch of the selector switch object 1003A is switched on the basis of the operation on an operation region on the left hand of the user, the device control unit 107 may generate an output signal corresponding to the switched state. More specifically, in a case in which the selector switch object 1003A which is an example of the operation target is configured to switch an illumination level of a lighting device which is an example of the operated device 50, the device control unit 107 may control the operated device 50 such that illuminance corresponding to a state indicated by the selector switch object 1003A is obtained. Accordingly, detailed control of the operated device 50 can be performed.

Further, in the present embodiment, control of display of selection by the display control unit 106 can be controlled, but the present technology is not limited to this example. For example, the function related to the display control unit 106 need not be necessarily set if feedback by display of selection for the user is unnecessary.

### <<4. Hardware Configuration Example>>

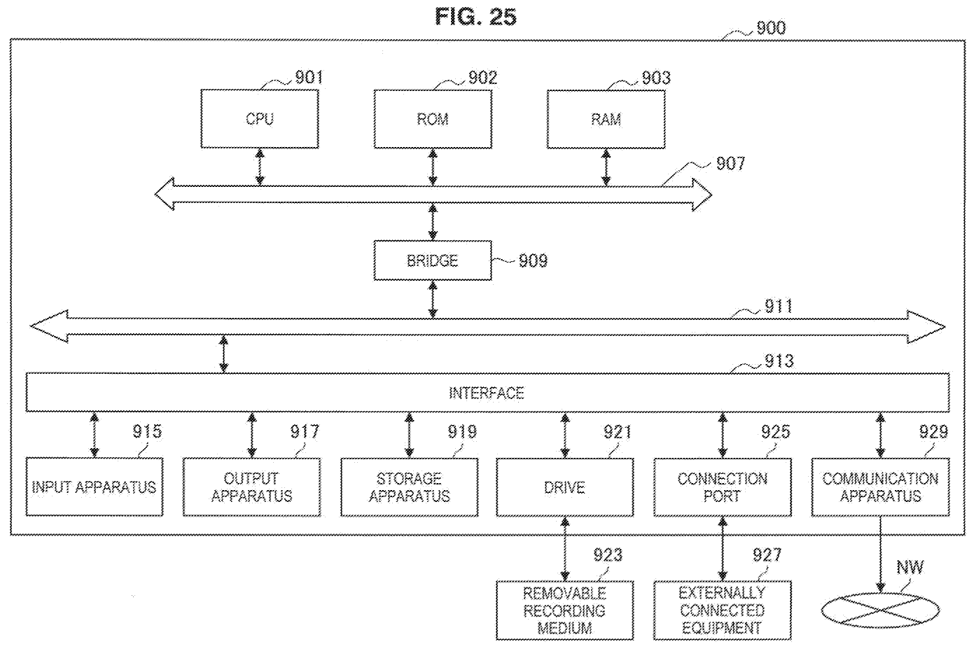

Next, the hardware configuration of an information processing apparatus 900 according to an embodiment of the present disclosure is described with reference to FIG. 25. FIG. 25 is a block diagram illustrating a hardware configuration example of the information processing apparatus 900 according to an embodiment of the present disclosure. The illustrated information processing apparatus 900 may realize the information processing device in the foregoing embodiment, for example.

The information processing apparatus 900 includes a central processing unit (CPU) 901, read-only memory (ROM) 903, and random-access memory (RAM) 905. In addition, the information processing apparatus 900 may include a host bus 907, a bridge 909, an external bus 911, an interface 913, an input apparatus 915, an output apparatus 917, a storage apparatus 919, a drive 921, a connection port 925, and a communication apparatus 929. In conjunction with, or in place of, the CPU 901, the information processing apparatus 900 may have a processing circuit called a digital signal processor (DSP) or application specific integrated circuit (ASIC).

The CPU 901 functions as an arithmetic processing unit and a control unit, and controls the whole operation in the information processing apparatus 900 or a part thereof in accordance with various programs recorded in the ROM 903, the RAM 905, the storage apparatus 919, or a removable recording medium 923. The ROM 903 stores programs, operation parameters, or the like used by the CPU 901. The RAM 905 temporarily stores programs used in the execution by the CPU 901, parameters that vary as appropriate in the execution, or the like. For example, the CPU 901, the ROM 903, and the RAM 905 may realize the functions of the control unit 100 in the foregoing embodiment. The CPU 901, the ROM 903, and the RAM 905 are connected with each other via the host bus 907 that includes an internal bus such as a CPU bus. Furthermore, the host bus 907 is connected to the external bus 911 such as peripheral component interconnect/interface (PCI) bus via the bridge 909.

The input apparatus 915 is, in one example, an apparatus operated by a user, such as a mouse, a keyboard, a touch panel, a button, a switch, and a lever. The input apparatus 915 may be, in one example, a remote control apparatus using infrared rays or other radio waves, or may be externally connected equipment 927 such as a cellular phone that supports the operation of the information processing apparatus 900. The input apparatus 915 includes an input control circuit that generates an input signal on the basis of the information input by the user and outputs it to the CPU 901. The user operates the input apparatus 915 to input various data to the information processing apparatus 900 and to instruct the information processing apparatus 900 to perform a processing operation.

The output apparatus 917 includes an apparatus capable of notifying visually or audibly the user of the acquired information. The output apparatus 917 may be a display apparatus such as a liquid crystal display (LCD), a plasma display panel (PDP), and an organic electro-luminescence display (OELD), an audio output apparatus such as a speaker and a headphone, as well as printer apparatus or the like. The output apparatus 917 outputs the result obtained by the processing of the information processing apparatus 900 as a video such as a text or an image, or outputs it as audio such as a speech or sound.

The storage apparatus 919 is a data storage apparatus configured as an example of a storage portion of the information processing apparatus 900. The storage apparatus 919 includes, in one example, a magnetic storage unit device such as hard disk drive (HDD), a semiconductor storage device, an optical storage device, and a magneto-optical storage device. The storage apparatus 919 stores programs executed by the CPU 901, various data, various types of data obtained from the outside, and the like.

The drive 921 is a reader-writer for a removable recording medium 923 such as a magnetic disk, an optical disk, a magneto-optical disk, and a semiconductor memory, and is incorporated in the information processing apparatus 900 or externally attached thereto. The drive 921 reads the information recorded on the loaded removable recording medium 923 and outputs it to the RAM 905. In addition, the drive 921 writes a record in the loaded removable recording medium 923. At least one of the storage apparatus 919, or the drive 921 and the removable recording medium 923 may realize the functions of the storage unit 120 in the foregoing embodiment.

The connection port 925 is a port for directly connecting equipment to the information processing apparatus 900. The connection port 925 may be, in one example, a Universal Serial Bus (USB) port, an IEEE 1394 port, or a Small Computer Device Interface (SCSI) port. In addition, the connection port 925 may be, in one example, an RS-232C port, an optical audio terminal, or High-Definition Multimedia Interface (HDMI, registered trademark) port. The connection of the externally connected equipment 927 to the connection port 925 makes it possible to exchange various kinds of data between the information processing apparatus 900 and the externally connected equipment 927.

The communication apparatus 929 is, in one example, a communication interface including a communication device or the like, which is used to be connected to the communication network NW. The communication apparatus 929 may be, in one example, a communication card for wired or wireless local area network (LAN), Bluetooth (registered trademark), or wireless USB (WUSB). In addition, the communication apparatus 929 may be, in one example, a router for optical communication, a router for asymmetric digital subscriber line (ADSL), or a modem for various communications. The communication apparatus 929 transmits and receives signals or the like using a predetermined protocol such as TCP/IP, in one example, with the Internet or other communication equipment. In addition, the communication network NW connected to the communication apparatus 929 is a network connected by wire or wireless, and is, in one example, the Internet, home LAN, infrared communication, radio wave communication, satellite communication, or the like. Note that at least one of the connection port 925 or the communication apparatus 929 may realize the functions of the communication unit 110 in the foregoing embodiment.

The above illustrates one example of a hardware configuration of the information processing apparatus 900.

### <<5. Conclusion>>

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Note that each of the steps in the processes of the information processing device in this specification is not necessarily required to be processed in a time series following the sequence described as a flowchart. For example, each of the steps in the processes of the information processing device may be processed in a sequence that differs from the sequence described herein as a flowchart, and furthermore may be processed in parallel.

Additionally, it is possible to create a computer program for causing hardware such as a CPU, ROM, and RAM built into an information processing device to exhibit functions similar to each component of the information processing device described above. In addition, a readable recording medium storing the computer program is also provided.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.
(1)

An information processing device, including:

a first selecting unit configured to control selection of a selection target including an operation target on the basis of information related to a first operation on the selection target by an operating entity;

a setting unit configured to set an operation region corresponding to the selected selection target in a first object; and

a second selecting unit configured to control selection of the operation target on the basis of information related to a second operation on the first object in which the operation region is set by the operating entity.
(2)

The information processing device according to (1), in which the information related to the first operation includes information obtained by estimating a form of a body of the operating entity facing the selection target.
(3)

The information processing device according to (1) or (2), in which the first operation includes an operation using the first object. (4)

The information processing device according to (3), in which the first operation includes an operation on a sensor configured to acquire a position, a form, and/or the like of the first object.
(5)

The information processing device according to (3) or (4), in which the first object is a part of a body of the operating entity.
(6)

The information processing device according to any one of (1) to (5), in which the first selecting unit holds a state in which the selection target is selected on the basis of information related to a third operation.
(7)

The information processing device according to (6), in which the first selecting unit releases the holding of the state in which the selection target is selected on the basis of information related to a fourth operation.
(8)

The information processing device according to any one of (1) to (7), in which the information related to the first operation includes information related to an operated position estimated by the first operation.
(9)

The information processing device according to any one of (1) to (8), in which the second operation includes an operation using a second object different from the first object.
(10)

The information processing device according to (9), in which the second operation includes an operation performed in a state in which the second object is caused to approach the first object.
(11)

The information processing device according to (9) or (10), in which the second operation includes an operation performed in a state in which the first object and the second object are in contact with each other.
(12)

The information processing device according to any one of (9) to (11), in which the second object is a part of a body of the operating entity.
(13)

The information processing device according to any one of (1) to (12), further including:

a display control unit configured to control display related to the selection by at least one of the first selecting unit or the second selecting unit.
(14)

The information processing device according to (13), in which the display control unit controls display related to a setting state of the operation region in the first object.
(15)

The information processing device according to any one of (1) to (14), further including:

a device control unit configured to control an operated device corresponding to the selected operation target.
(16)

The information processing device according to any one of (1) to (15), in which the second operation includes an operation for changing a state of the operation target.
(17)

The information processing device according to any one of (1) to (16), in which, in a case in which only one operation target is included in the selection target,

the first selecting unit selects the operation target.
(18)

The information processing device according to any one of (1) to (17), in which the operation target includes a virtual object displayed in a display region.
(19)

An information processing method, including:

controlling, by a processor, selection of a selection target including an operation target on the basis of information related to a first operation on the selection target by an operating entity;

setting, by the processor, an operation region corresponding to the selected selection target in a first object; and

controlling, by the processor, selection of the operation target on the basis of information related to a second operation on the operation region set in the first object by the operating entity.
(20)

A program causing a computer to function as:

a first selecting unit configured to control selection of a selection target including an operation target on the basis of information related to a first operation on the selection target by an operating entity;

a setting unit configured to set an operation region corresponding to the selected selection target in a first object; and

a second selecting unit configured to control selection of the operation target on the basis of information related to a second operation on the first object in which the operation region is set by the operating entity.

### REFERENCE SIGNS LIST

1A, 1B, 1C information processing system
10 information processing device
20 object detecting device
30 display device
31 display region
40 operating body detecting device
50 operated device
100, 100C control unit
101 operated position estimating unit
102 operation recognizing unit
103 first selecting unit
104 setting unit
105 second selecting unit
106 display control unit
107 device control unit
110 communication unit
120 storage unit

1. An information processing device, comprising:
a first selecting unit configured to control selection of a selection target including an operation target on a basis of information related to a first operation on the selection target by an operating entity;
a setting unit configured to set an operation region corresponding to the selected selection target in a first object; and
a second selecting unit configured to control selection of the operation target on a basis of information related to a second operation on the first object in which the operation region is set by the operating entity.

2. The information processing device according to claim 1, wherein the information related to the first operation includes information obtained by estimating a form of a body of the operating entity facing the selection target.

3. The information processing device according to claim 1, wherein the first operation includes an operation using the first object.

4. The information processing device according to claim 3, wherein the first operation includes an operation on a sensor configured to acquire a position, a form, and/or the like of the first object.

5. The information processing device according to claim 3, wherein the first object is a part of a body of the operating entity.

6. The information processing device according to claim 1, wherein the first selecting unit holds a state in which the selection target is selected on a basis of information related to a third operation.

7. The information processing device according to claim 6, wherein the first selecting unit releases the holding of the state in which the selection target is selected on a basis of information related to a fourth operation.

8. The information processing device according to claim 1, wherein the information related to the first operation includes information related to an operated position estimated by the first operation.

9. The information processing device according to claim 1, wherein the second operation includes an operation using a second object different from the first object.

10. The information processing device according to claim 9, wherein the second operation includes an operation performed in a state in which the second object is caused to approach the first object.

11. The information processing device according to claim 9, wherein the second operation includes an operation performed in a state in which the first object and the second object are in contact with each other.

12. The information processing device according to claim 9, wherein the second object is a part of a body of the operating entity.

13. The information processing device according to claim 1, further comprising:
a display control unit configured to control display related to the selection by at least one of the first selecting unit or the second selecting unit.

14. The information processing device according to claim 13, wherein the display control unit controls display related to a setting state of the operation region in the first object.

15. The information processing device according to claim 1, further comprising:
a device control unit configured to control an operated device corresponding to the selected operation target.

16. The information processing device according to claim 1, wherein the second operation includes an operation for changing a state of the operation target.

17. The information processing device according to claim 1, wherein, in a case in which only one operation target is included in the selection target,
the first selecting unit selects the operation target.

18. The information processing device according to claim 1, wherein the operation target includes a virtual object displayed in a display region.

19. An information processing method, comprising:
controlling, by a processor, selection of a selection target including an operation target on a basis of information related to a first operation on the selection target by an operating entity;
setting, by the processor, an operation region corresponding to the selected selection target in a first object; and
controlling, by the processor, selection of the operation target on a basis of information related to a second operation on the operation region set in the first object by the operating entity.

20. A program causing a computer to function as:
a first selecting unit configured to control selection of a selection target including an operation target on a basis of information related to a first operation on the selection target by an operating entity;
a setting unit configured to set an operation region corresponding to the selected selection target in a first object; and
a second selecting unit configured to control selection of the operation target on a basis of information related to a second operation on the first object in which the operation region is set by the operating entity.
